(19) United States
(12) Patent Application Publication
(10) Pub. No.: US 2018/0268242 A1
(43) Pub. Date: Sep. 20, 2018

(54) IMAGE CONTENT COMMENTING METHOD AND IMAGE MANAGEMENT SYSTEM

(71) Applicant: VIVOTEK INC., New Taipei City (TW)

(72) Inventor: Chien-Wen Liu, New Taipei City (TW)

(21) Appl. No.: 15/925,684

(22) Filed: Mar. 19, 2018

(30) Foreign Application Priority Data
Mar. 20, 2017 (TW) 106109070

(51) Int. Cl. G06K 9/32; G06T 7/246; H04N 21/235; H04N 21/845

(52) U.S. Cl. CPC G06K 9/3241; G06T 7/248; G06T 2207/10016; H04N 21/8455; H04N 21/2353

(57) ABSTRACT

An image content commenting method and a related image management system can be utilized to establish a commenting record about partial content of an image stream. The image content commenting method includes reading a coordinate value of a cursor within a first image frame of the image stream, selecting a pattern object inside the first image frame according to the coordinate value, establishing connection between a first bookmark and the pattern object, and identifying the pattern object from a second image frame of the image stream and then connecting the first bookmark with the pattern object inside the second image frame.

### BACKGROUND OF THE INVENTION

### 1. Field of the Invention

The present invention relates to an image content commenting method and an image management system, and more particularly, to an image content commenting method and a related image management system capable of establishing a commenting record about partial content of an image stream.

### 2. Description of the Prior Art

Conventional image commenting technique establishes a comment upon the whole image frame, and the user can search the comment by a keyword inside the comment, an establishing time of the comment, a mark about the comment, an account of the establishment or a topic of the establishment, so as to find out a few of specific image frames from an image stream composed of plural image frames. However, different users may establish dissimilar comments to a similar event; for example, the user may establish a comment “doors are damaged by a thief” about an image frame containing a car, and the other user may establish the comment “parked three days before” about the same image frame containing the car. The foresaid comments does not include a keyword “car”, so the searcher may surmise lots of keywords but still cannot find the needed image frame about the car within the image stream. Thus, design of an image content commenting method dissimilar to the conventional image commenting technique which comments upon the whole image frame is an important issue in the related monitoring industry.

### SUMMARY OF THE INVENTION

The present invention provides an image content commenting method and a related image management system capable of establishing a commenting record about partial content of an image stream for solving above drawbacks.

According to the claimed invention, an image content commenting method is utilized to establish a commenting record about partial content of an image stream. The image content commenting method includes reading a coordinate value of a cursor within a first image frame of the image stream, selecting a pattern object inside the first image frame according to the coordinate value, establishing connection between a first bookmark and the pattern object, and identifying the pattern object from a second image frame of the image stream and then connecting the first bookmark with the pattern object inside the second image frame.

According to the claimed invention, an image management system with an image content commenting function includes a display device, a navigation device and an operational processor. The display device is adapted to play an image stream and a related bookmark. The navigation device is adapted to generate a cursor for shifting within an image frame of the image stream. The operational processor is electrically connected to the display device and the navigation device. The operational processor is adapted to read a coordinate value of a cursor within a first image frame of the image stream, to select a pattern object inside the first image frame according to the coordinate value, to establish connection between a first bookmark and the pattern object, and to identify the pattern object from a second image frame of the image stream and then connecting the first bookmark with the pattern object inside the second image frame.

The image content commenting method of the present invention does not comment upon the whole image frame, but can establish the commenting record and the bookmark about one or more specific pattern objects within the image frame. The pattern object appeared on different image frames can be marked by different bookmarks. The user can utilize the navigation device to designate the pattern object, and the bookmark relevant to the designated pattern object within the image frames can be searched accordingly, so the user is able to realize situations of the pattern object at different timing. As the bookmark is selected, the detailed commenting record can be showed on the display device or the image stream can be played at the establishing time of the bookmark (which means the establishing time of the relevant image frame), so that the user can conveniently search the specific monitored object from database.

The image content commenting method of the present invention can effectively increase accuracy of searching the bookmark. For example, the first bookmark and the second bookmark mentioned above are both relevant to the car, but the statements about the car may be different because of user's personal wording; such like the first bookmark does not have a keyword “car”. If the user utilizes conventional image commenting technique, which comments the whole image frame, to search the bookmark, the first image frame and the first bookmark are missed while using the keyword “car” for searching, and the first and second image frames and the first and second bookmarks are missed while using the keyword “vehicle” for searching. The image content commenting method of the present invention can directly designate the pattern object inside the image frame instead of surmising all possible keyboards, so that the present invention provides preferred searching accuracy and increases filtering and analyzing efficiency of the image content commenting method.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image management system according to an embodiment of the present invention.

FIG. 2 is a flow chart of an image content commenting method applied to the image management system according to the embodiment of the present invention.

FIG. 3 and FIG. 4 respectively are diagrams of different image frames according to the embodiment of the present invention.

### DETAILED DESCRIPTION

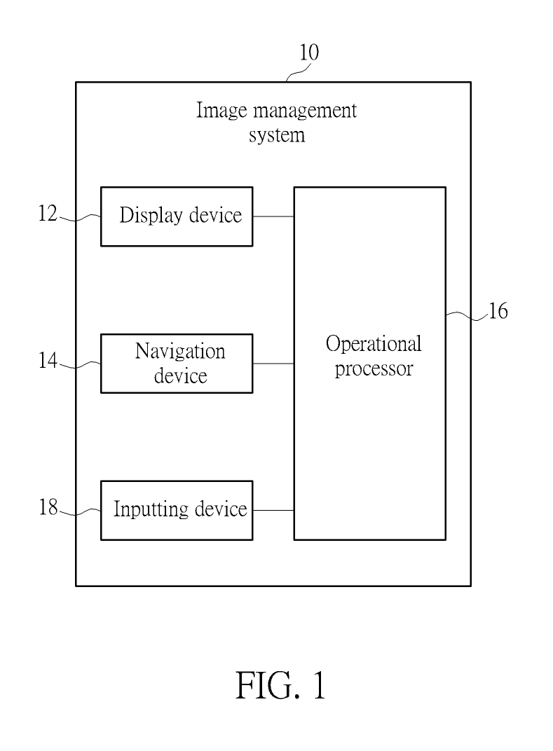

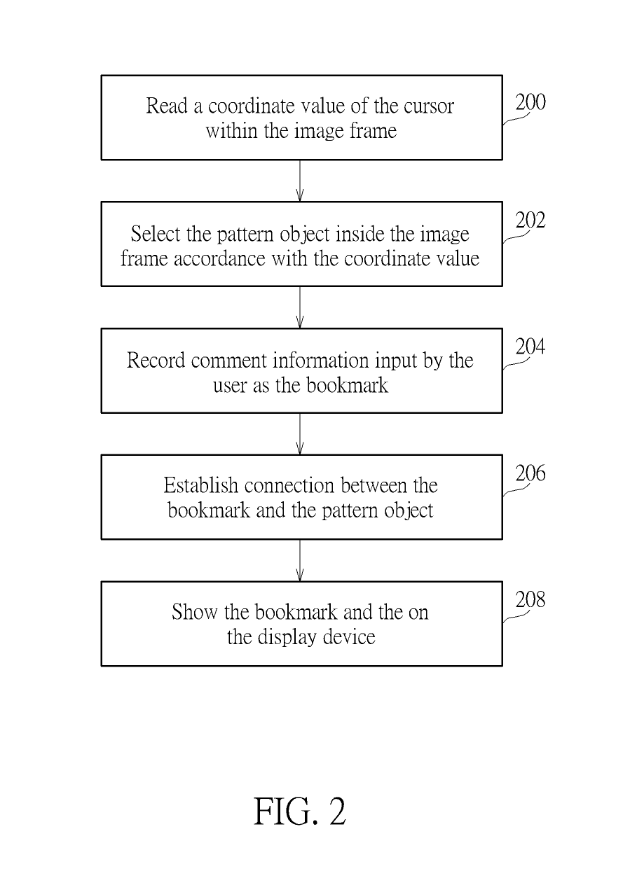

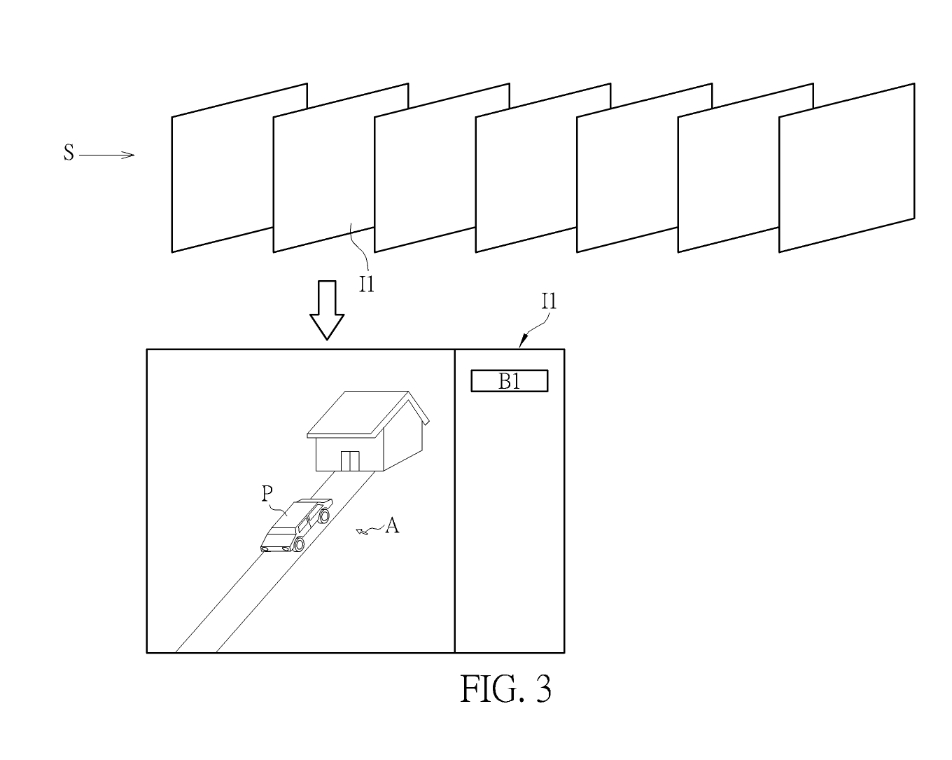

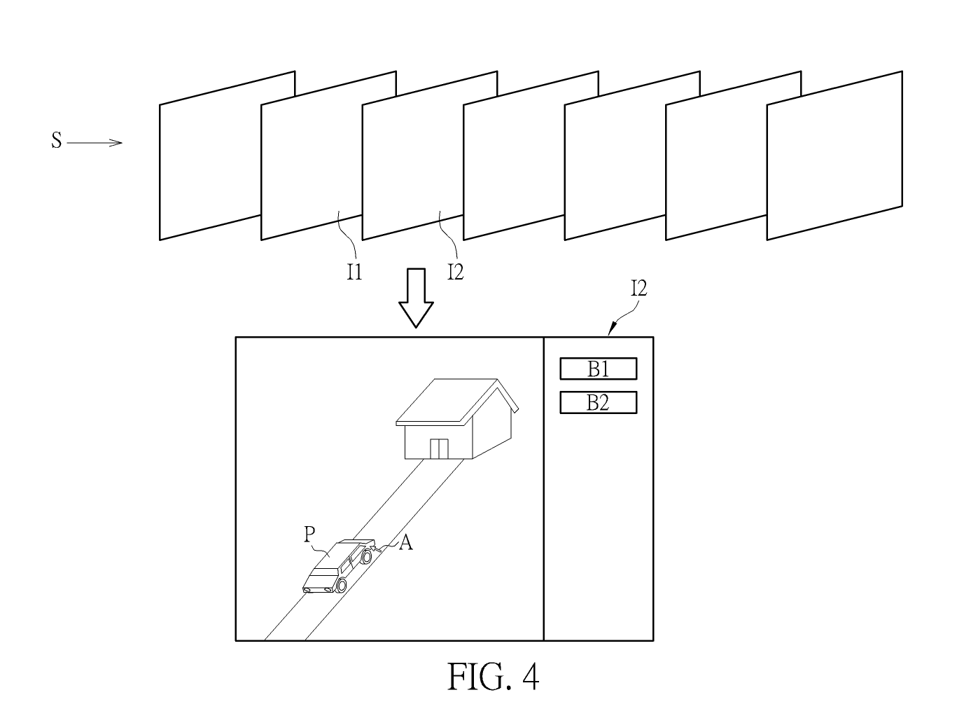

Please refer to FIG. 1 to FIG. 4. FIG. 1 is a functional block diagram of an image management system 10 according to an embodiment of the present invention. FIG. 2 is a flow chart of an image content commenting method applied to the image management system 10 according to the embodiment of the present invention. FIG. 3 and FIG. 4 respectively are diagrams of different image frames according to the embodiment of the present invention. The image management system 10 can include a display device 12, a navigation device 14 and an operational processor 16. The display device 12 is used to display an image stream S and related bookmarks. The image stream S may have a plurality of image frames, such as at least including the image frames I1 and I2. The bookmark is a commenting record about a specific pattern object within the image stream S. The navigation device 14 can be a mouse, a touch pad, and a trackball. The user can push or pull the navigation device 14 to shift a cursor A displayed on the display device 12 within any image frame of the image stream S. The operational processor 16 is electrically connected to the display device 12 and the navigation device 14, and adapted to execute the image content commenting method for establishing and searching the commenting record.

The image content commenting method of the present invention can establish the commenting record about partial content inside any image frame of the image stream S, and does not comment the whole image frame or a part of the image stream. The user can move the navigation device 14 to shift the cursor A within the image frame, so as to locate the cursor A at a position within the image frame prepared for writing the comment. Then, the operational processor 16 executes step 200 and step 202 of the image content commenting method to read a coordinate value of the cursor A within the first image frame I1, and to select a pattern object P inside the first image frame I1 relevant to the cursor A in accordance with the coordinate value. In step 202, the image content commenting method may represent a pattern closest to the coordinate value as the pattern object P. For example, the car within the first image frame I1 is close to the cursor A rather than the house, so a pattern of the car is represented as the pattern object P. Further, the image content commenting method may identify whether the cursor A is covered by a contour of some pattern within the image frame, and the contour of the said pattern which covers the coordinate value is represented as the pattern object P. Moreover, the user can operate the cursor A to draw a closed curve within the first image frame I1, such as a polygon or a circle, and the image content commenting method can define the pattern covered by a varied range of the coordinate value (which means the closed curve) of the cursor A is represented as the pattern object P. Application of using the cursor A to select the pattern object is not limited to the above-mentioned embodiments, which depends on design demand.

The image management system 10 can further include an inputting device 18 electrically connected to the operational processor 16. As the pattern object P within the first image frame I1 is selected, the inputting device 18 can be used to input comment information about the pattern object P. For example, the pattern object P is the car, so the comment information can be color of vehicle body, damage situation or any recordable data. Then, step 204, step 206 and step 208 are executed that the image content commenting method can record the comment information input by the user as the first bookmark B1, and establish connection between the first bookmark B1 and the pattern object P; meanwhile, the display device 12 can optionally show the first bookmark B1 at the same time. A captured timing of the first image frame I1 is previous to a captured timing of the second image frame I2 in the image stream S. The image content commenting method can be used to determine whether the later image frame (such as the second image frame I2 and other following image frames) has the pattern object P while the connection between the pattern object P and the first bookmark B1 within the first image frame I1 is established; if the second image frame I2 has the same pattern object P, the image content commenting method can combine the first bookmark B1 with the pattern object P within the second image frame I2, which means the pattern object P all appearing in the image stream S can be linked to the bookmark B1.

The image content commenting method further can optionally establish connection between the second bookmark B2 and the pattern object P within the second image frame I2, such as a statement “parking before the house” recorded as the first bookmark B1, and a statement “the car departing from the house” recorded as the second bookmark B2. The image content commenting method can comment different statements about the pattern object at different timing. An establishment process of the second bookmark B2 is similar to the first bookmark B1, and a detailed description is omitted for simplicity. While a plurality of pattern objects P is existed in the image frame, each pattern object P not only has an exclusive marked serial number, but also can be marked by one or more bookmarks. As establishing the connection between the bookmark and the pattern object P, the image content commenting method preferably can record the coordinate value of the cursor A (which represents position of the pattern object P within the image frame), the captured timing of the first image frame I1 and the second image frame I2 (which represents an establishing time of the pattern object P within the image stream S), and/or the marked serial number of the pattern object P (which is used to identify the specific pattern object from the plurality of pattern objects P within the image frame). Parameters recorded during establishment of the connection between the bookmark and the pattern object P are not limited to the above-mentioned embodiments, and depend on actual demand.

For searching the bookmark relevant to the specific pattern object within the image stream S, the user can input a designated coordinate range, and accordingly the image management system 10 can sift one or more pattern objects P in accordance with the designated coordinate range and show the relevant bookmarks on the display device 12. Meanwhile, the user can choose any of the bookmarks, and the display device 12 can show the commenting record about the bookmark or play the image stream S at an establishing time of the chosen bookmark. In addition, the user may use the navigation device 14 to move the cursor A, and the image content commenting method can determine whether the cursor A is relevant to the specific pattern object P according to position of the cursor A within the image frame. Method of determining the relevant connection between the cursor A and the pattern object P can refer to step 202, such as representing the pattern closest to the cursor A as the pattern object P, representing the contour of the pattern covering the cursor A as the pattern object P, or representing the pattern covered by the varied range of the coordinate value about the cursor A as the pattern object P. Determination of the connection between the cursor A and the pattern object P is not limited to the above-mentioned embodiments, which depends on actual demand.

As mentioned above, the image content commenting method can establish the first bookmark B1 focused on the pattern object P within the first image frame I1, and further can establish the second bookmark B2 focused on the same pattern object P within the second image frame I2. In searching the relevant bookmarks, the image content commenting method only shows the first bookmark B1 on the display device 12 while the cursor A is pointed to the pattern object P (for forming relevance) within the first image frame I1, and optionally the image stream S can be played at the establishing time of the first bookmark B1. If the cursor A is pointed to the pattern object P within the second image frame I2 to form the relevance, the image content commenting method can simultaneously show the first bookmark B1 and the second bookmark B2 on the display device 12, and the image stream S can be played at the establishing time of the first bookmark B1 or the second bookmark B2 alternatively.

In conclusion, the image content commenting method of the present invention does not comment upon the whole image frame, but can establish the commenting record and the bookmark about one or more specific pattern objects within the image frame. The pattern object appeared on different image frames can be marked by different bookmarks; for example, the car in FIG. 3 is marked by the first bookmark as “parking before the house”, and the car in FIG. 4 is marked by the second bookmark as “the car departed from the house”. The user can utilize the navigation device to designate the pattern object, and the bookmark relevant to the designated pattern object within the image frames can be searched accordingly, so the user is able to realize situations of the pattern object at different timing. As the bookmark is selected, the detailed commenting record can be showed on the display device or the image stream can be played at the establishing time of the bookmark (which means the establishing time of the relevant image frame), so that the user can conveniently search the specific monitored object from database.

Besides, the image content commenting method of the present invention can effectively increase accuracy of searching the bookmark. For example, the first bookmark and the second bookmark mentioned above are both relevant to the car, but the statements about the car may be different because of user's personal wording; such like the first bookmark does not have a keyword “car”. If the user utilizes conventional image commenting technique, which comments the whole image frame, to search the bookmark, the first image frame and the first bookmark are missed while using the keyword “car” for searching, and the first and second image frames and the first and second bookmarks are missed while using the keyword “vehicle” for searching. The image content commenting method of the present invention can directly designate the pattern object inside the image frame instead of surmising all possible keyboards, so that the present invention provides preferred searching accuracy and increases filtering and analyzing efficiency of the image content commenting method.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image content commenting method utilized to establish a commenting record about partial content of an image stream, the image content commenting method comprising:
reading a coordinate value of a cursor within a first image frame of the image stream;
selecting a pattern object inside the first image frame according to the coordinate value;
establishing connection between a first bookmark and the pattern object; and
identifying the pattern object from a second image frame of the image stream and then connecting the first bookmark with the pattern object inside the second image frame.

2. The image content commenting method of claim 1, further comprising:
determining whether the coordinate value of the cursor is relevant to the pattern object within the first image frame or the second image frame; and
determining whether to display the first bookmark on a display device according to a determination result.

3. The image content commenting method of claim 1, further comprising:
determining whether the cursor selects the pattern object; and
playing the image stream at an establishing time of the first bookmark according to a determination result.

4. The image content commenting method of claim 1, further comprising:
recording commenting information input by an inputting device as the first bookmark.

5. The image content commenting method of claim 1, wherein the image content commenting method further optionally establishes connection between a second bookmark and the pattern object within the second image frame, the image content commenting method further comprises:
determining whether the coordinate value of the cursor is relevant to the pattern object within the second image frame; and
determining whether to display the first bookmark and the second bookmark on a display device according to a determination result.

6. The image content commenting method of claim 5, further comprising:
determining whether the cursor selects the pattern object; and
playing the image stream at an establishing time of the second bookmark according to a determination result.

7. The image content commenting method of claim 5, further comprising:
recording commenting information input by an inputting device corresponding to the first image frame and the second image frame respectively as the first bookmark and the second bookmark.

8. The image content commenting method of claim 1, further comprising:
representing a pattern closest to the coordinate value, or a contour of a pattern covering the coordinate value, or a contour of a pattern covered by a varied range of the coordinate value as the pattern object.

9. The image content commenting method of claim 1, wherein the image stream at least comprises the first image frame and the second image frame, and a captured timing of the first image frame is previous to a captured timing of the second image frame.

10. The image content commenting method of claim 1, wherein the image content commenting method establishes the connection about the first bookmark in accordance with at least one of the coordinate value, captured timing of the first image frame and the second image frame, and a marked serial number of the pattern object.

11. An image management system with an image content commenting function, the image management system comprising:
a display device adapted to play an image stream and a related bookmark;
a navigation device adapted to generate a cursor for shifting within an image frame of the image stream; and
an operational processor electrically connected to the display device and the navigation device, the operational processor being adapted to read a coordinate value of a cursor within a first image frame of the image stream, to select a pattern object inside the first image frame according to the coordinate value, to establish connection between a first bookmark and the pattern object, and to identify the pattern object from a second image frame of the image stream and then connecting the first bookmark with the pattern object inside the second image frame.

12. The image management system of claim 11, wherein the operational processor is further adapted to determine whether the coordinate value of the cursor is relevant to the pattern object within the first image frame or the second image frame, and to determine whether to display the first bookmark on a display device according to a determination result.

13. The image management system of claim 11, wherein the operational processor is further adapted to determine whether the cursor selects the pattern object, and to play the image stream at an establishing time of the first bookmark according to a determination result.

14. The image management system of claim 11, wherein the operational processor is further adapted to record commenting information input by an inputting device as the first bookmark.

15. The image management system of claim 11, wherein the image content commenting method further optionally establishes connection between a second bookmark and the pattern object within the second image frame, the operational processor is further adapted to determine whether the coordinate value of the cursor is relevant to the pattern object within the second image frame, and to determine whether to display the first bookmark and the second bookmark on a display device according to a determination result.

16. The image management system of claim 15, wherein the operational processor is further adapted to determine whether the cursor selects the pattern object, and to play the image stream at an establishing time of the second bookmark according to a determination result.

17. The image management system of claim 15, wherein the operational processor is further adapted to record commenting information input by an inputting device corresponding to the first image frame and the second image frame respectively as the first bookmark and the second bookmark.

18. The image management system of claim 11, wherein the operational processor is further adapted to represent a pattern closest to the coordinate value, or a contour of a pattern covering the coordinate value, or a contour of a pattern covered by a varied range of the coordinate value as the pattern object.

19. The image management system of claim 11, wherein the image stream at least comprises the first image frame and the second image frame, and a captured timing of the first image frame is previous to a captured timing of the second image frame.

20. The image management system of claim 11, wherein the image content commenting method establishes the connection about the first bookmark in accordance with at least one of the coordinate value, captured timing of the first image frame and the second image frame, and a marked serial number of the pattern object.
